(19) United States
(12) Patent Application Publication
(10) Pub. No.: US 2005/0104851 A1
(43) Pub. Date: May 19, 2005

(54) Cursor simulator and a simulation method thereof for using a laser beam to control a cursor

(76) Inventors: Chia-Chang Hu, Tao Yuan City (TW); Xiaohong Wei, Tao Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/713,011

(22) Filed: Nov. 17, 2003

(51) Int. Cl. G09G 5/08

(52) U.S. Cl. 345/157

(57) ABSTRACT

The present invention relates to a cursor simulator and a simulation method thereof for using a laser beam to control a cursor. The cursor simulator has a receiving module for receiving the first and second optical signals, a position corresponding module for corresponding the view scope of the optical reading device to the display frame of the screen, a display module for detecting the optical signal display position on the display frame and displaying the optical signal on the display frame of the screen, a wavelength parameter acquiring module for acquiring the wavelength parameter of the first optical signal and a positioning module for reading the color parameter of each optical signal display position. When the color parameter is approximately equal to the wavelength parameter, the positioning module records the optical signal display position, and generates a cursor simulating position according to the recorded optical signal display positions.

### BACKGROUND OF THE INVENTION

1. Field of the Invention

The present invention relates to a cursor simulator and a simulation method thereof for using a laser beam to control a cursor, and particularly, to a cursor simulator and a simulation method thereof for controlling the position of a cursor and generating commands with a laser beam emitted by a laser pointer pen.

2. Description of the Prior Art

As information technology advances with high speed, computers have nearly become a requirement for everyone. In particular, with regard to job reports and product introduction, the computer has replaced the traditional projector and slides, and is widely used for briefings and computer teaching.

When using a computer for a briefing, the facility and efficiency of the whole process is greatly improved if the presenter can remotely control the cursor on the screen. Therefore, many companies have developed a computer peripheral device called a pointer in response to this consumer need.

Examples on the market are the RF pointer manufactured by Acrox and the multi-media pointer by the GIGABYTE. Wireless communication allows the presenter to remotely control the cursor on the computer by means of the pointer, thus replacing the traditional mouse. The pointer is composed of a remote control and a receiver. The remote control functions as the wireless mouse and emits a laser beam for pointing and directing. The receiver is installed in the computer for receiving the laser beam emitted by the remote control to control the cursor.

In order to achieve the object of remotely controlling the cursor, the user has to further purchase a pointer. This is an additional expense. Further, because the remote control and the receiver of the pointer have to cooperate with each other, the user has to buy a new pointer if the remote control or the receiver is lost or malfunctioning, unless the pointer manufacturer is willing to sell the just remote control or the receiver. Furthermore, the pointer has only one function, that of remote control during a briefing, and therefore the pointer becomes “electronic garbage” if the briefings are no longer required.

Therefore, the present invention provides a cursor simulator and a simulation method thereof for using a laser beam to control a cursor so as to resolve the mentioned problem. The cursor simulator includes cursor simulation software, and the user can install this software in a computer and use a laser pointer pen and a video camera for remotely controlling a cursor.

### SUMMARY OF THE INVENTION

The present invention relates to a cursor simulator and a simulation method thereof for using a laser beam to control a cursor. The cursor simulator can use the laser beam emitted by a laser pointer pen to control the position of the cursor and generate commands. Therefore, the cursor simulator can replace the traditional cursor control device, such as a mouse or a pointer.

The cursor simulator according to the present invention is installed in a main system. The main system comprises a screen having a predetermined display frame for displaying a cursor. The main system is connected to an optical reading device having a predetermined view scope. When the optical reading device receives a plurality of first optical signals and a plurality of second optical signals or only receives a plurality of second optical signals, it will transmit the first and second optical signals to the main system. The main system will transmit the first and second optical signals to the cursor simulator. The cursor simulator comprises a receiving module for receiving the first and second optical signals. A position corresponding module corresponds to the view scope of the optical reading device to the display frame of the screen so as to make each of the positions in the view scope correspond to an optical signal display position on the display frame. A display module detects the optical signal display position on the display frame corresponding to the position of the first or the second optical signal in the view scope and displays the first or the second optical signal on the display frame of the screen. A wavelength parameter acquiring module acquires the wavelength parameter of the first optical signal according to a first color parameter of the optical signal display position before displaying the first optical signal and a second color parameter after displaying the first optical signal. A positioning module reads the color parameter of each of the optical signal display positions on the display frame. When the color parameter is approximately equal to the wavelength parameter, the positioning module will record the optical signal display position, and then generate a cursor simulating position according to the recorded optical signal display positions.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram showing the application of a cursor simulator according to the present invention;

FIG. 2 is a perspective diagram of a cursor simulator according to the present invention;

FIG. 3 is a flowchart of a cursor simulating method according to the present invention; and

FIG. 4 is an embodiment according to the present invention.

### DETAILED DESCRIPTION OF THE PREFERRED EMBODIMENT

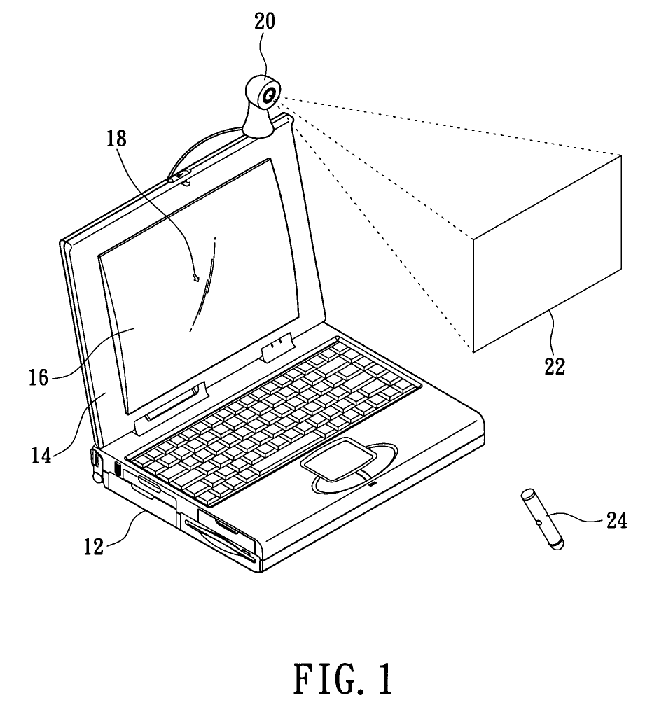

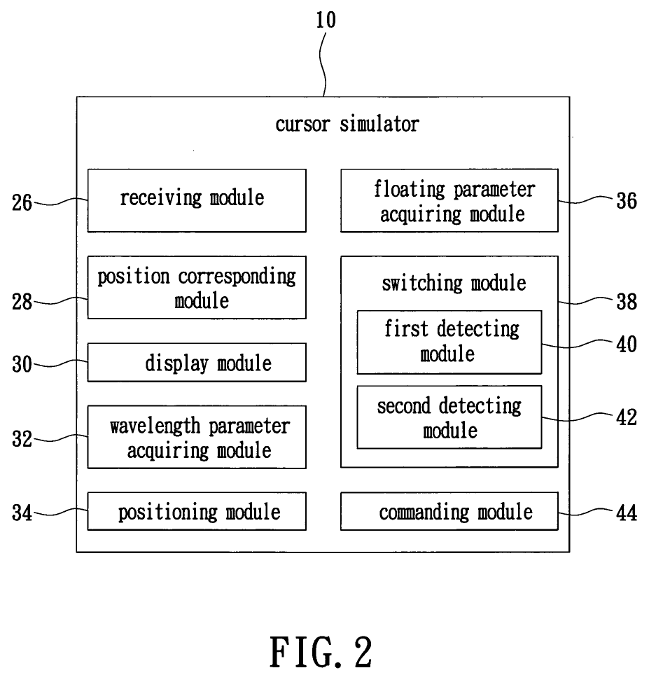

Reference is made to FIG. 1. FIG. 1 is a perspective diagram showing the application of a cursor simulator 10 according to the present invention. The cursor simulator 10 as shown in FIG. 2 is a cursor simulation software to be installed in a main system 12. In this embodiment, the main system 12 is a notebook. The main system 12 comprises a display device 14 having a predetermined display frame 16 for displaying a cursor 18. The main system 12 is connected to an optical reading device 20, such as a video camera. The optical reading device 20 has a predetermined view scope 22. When the optical reading device 20 receives a plurality of first optical signals and a plurality of second optical signals or only receives a plurality of second optical signals, it will transmit the first and second optical signals to the main system 12, and then the main system 12 will transmit the first and second optical signals to the cursor simulator 10.

As shown in FIG. 1, the user uses a laser pointer pen 24 to emit the laser beam. When the user positions the laser pointer pen 24 in the view scope 22 of the optical reading device 20 and uses it to emit the laser beam, the optical reading device 20 will read the laser beam and other images, such as the wall and human shadows, which cannot radiate. The optical reading device 20 will transform the laser beam into a plurality of first optical signals and transform the other images into a plurality of second optical signals.

If the user does not position the laser pointer pen 24 in the view scope 22 of the optical reading device 20 or the laser pointer pen 24 does not emit the laser beam, the optical reading device 20 will only read the other images. Therefore, the optical reading device 20 will only transform the other images into a plurality of second optical signals.

Reference is made to FIG. 2. FIG. 2 is a perspective diagram of a cursor simulator 10 according to the present invention. The cursor simulator 10 comprises a receiving module 26, a position corresponding module 28, a display module 30, a wavelength parameter acquiring module 32, a positioning module 34, a floating parameter acquiring module 36, a switching module 38, and a commanding module 44.

The receiving module 26 is used for receiving the first and second optical signals. The position corresponding module 28 is used for corresponding the view scope 22 of the optical reading device 20 to the display frame 16 of the display device 14 so that each of the positions in the view scope 22 corresponds to a position on the display frame 16.

The display module 30 is used for detecting the position on the display frame 16 corresponding to the position of the first or the second optical signal in the view scope 22 and displaying the first or the second optical signal on a simulation display frame (not shown). The simulation display frame comprises a plurality of optical signal display positions, and each of the optical signal display positions corresponds to a specific position on the display frame 16.

The wavelength parameter acquiring module 32 is used for acquiring the wavelength parameter of the first optical signal according to a first color parameter of the optical signal display position before displaying the first optical signal and a second color parameter after displaying the first optical signal. When the display module 30 displays the first and second optical signals on the simulation display frame, the color parameter (the second color parameter) of the first optical signal will be greatly different from the color parameter (the first color parameter) of the second optical signal because the first optical signal is produced from the laser beam and the second optical signal is produced from images other than the laser beam. Therefore, the wavelength parameter acquiring module 32 can obtain the wavelength parameter of the first optical signal, namely, the color wavelength value of the laser beam, by reading the first color parameter of the optical signal display position before displaying the first optical signal and the second color parameter after displaying the first optical signal.

The floating parameter acquiring module 36 is used for acquiring a floating parameter according to the different color parameters of the second optical signals displayed on the simulation display frame in different times. Even in a stable environment, the color parameters of the specific image read in the different times by the optical reading device 20 will be different. Namely, there is an error range in the color parameter. Therefore, the cursor simulator 10 will apply the floating parameter acquiring module 36 to detect the error value. The floating parameter acquiring module 36 will read the color parameters of the specific image in the specific area in the different times, and obtain the difference between the two neighboring color parameters, namely, the error value of the two neighboring color parameters, so as to detect the floating parameter. The user can set the floating parameter acquiring module 36 to perform a specific number of times of reading so as to obtain widespread sampling. In this embodiment, the floating parameter acquiring module 36 chooses the maximum value in all of the calculated error values as the floating parameter.

The positioning module 34 is used for reading the color parameter of each of the optical signal display positions on the simulation display frame. When the color parameter is approximately equal to the wavelength parameter of the laser beam, the positioning module 34 will record the optical signal display position, and generate a cursor simulating position according to all of the recorded optical signal display positions. For example, the positioning module 34 will detect the central point in the cluster composed of all of the optical signal display positions as the cursor simulating position. The color parameter is approximately equal to the wavelength parameter while the difference between the color parameter and the wavelength parameter is less than or equal to the floating parameter.

The switching module 38 is used for switching the cursor simulator 10 between a command mode and a movement mode. As shown in FIG. 2, the switching module 38 comprises a first detecting module 40 for detecting whether the cursor simulating position is equal to a first position in a specific period. If yes, then the switching module 38 will generate a first switching signal for switching the cursor simulator 10 to the command mode. The switching module 38 also comprises a second detecting module 42 for detecting whether the cursor simulating position is equal to a second position in a specific period. If yes, the switching module 38 will generate a second switching signal for switching the cursor simulator 10 to the movement mode.

When the cursor simulator 10 is in the movement mode, the cursor simulating position generated by the positioning module 34 of the cursor simulator 10 is displayed on the position of the cursor 18 on the display frame 16. When the cursor simulator 10 is in the command mode, the positioning module 34 will record all of the generated cursor simulating positions, and then generate a command code according to the cursor simulating positions.

The commanding module 44 has a command table (not shown). The table comprises a plurality of commands and a plurality of command codes. Each of the commands corresponds to one command code. The commanding module 44 will use the table to detect the corresponding command according the command code generated by the positioning module 34, and then the cursor simulator 10 will send out this command.

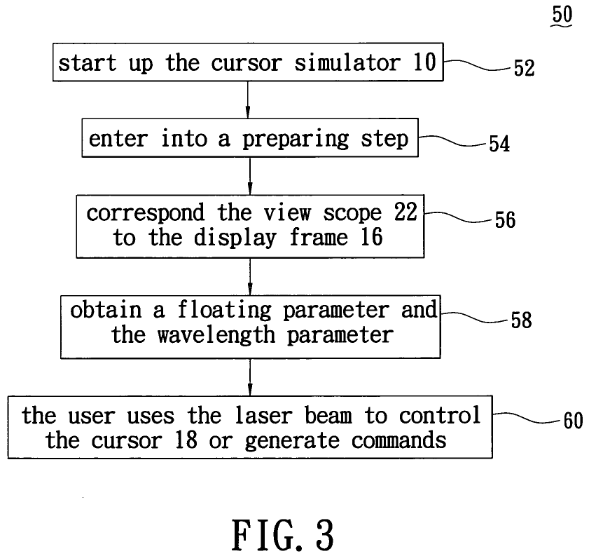

Reference is made to FIG. 3. FIG. 3 is a flowchart of a cursor simulating method 50 according to the present invention. Initially, the user has to start up the cursor simulator 10 (step 52). Thereafter, the cursor simulator 10 will enter into a preparation step where the operating system of the main system 12 will prepare to simulate the cursor (step 54). Then, the position corresponding module 28 will correspond the view scope 22 of the optical reading device 20 to the display frame 16 of the display device 14 (step 56).

The user can set the optical reading device 20 to correspond automatically the view scope 22 to the display frame 16, namely, to automatically set the view scope 22 of the optical reading device 20. The cursor simulator 10 can also be set to ask the user to set the view scope 22 of the optical reading device 20 manually after the operating system of the main system 12 finishes preparation for simulating the cursor. Once the view scope 22 is determined, the user has to operate the laser pointer pen 24 within the view scope 22 so as to control the cursor and send commands.

In the step 58, the cursor simulator 10 will use the floating parameter acquiring module 36 to obtain a floating parameter, and use the wavelength parameter acquiring module 32 to obtain the wavelength parameter of the laser beam. The cursor simulator 10 will display a specific area on the display frame 16. For example, the green bold line is used for circumscribing the specific area, and the user has to operate the laser beam within this specific area. Therefore, the wavelength parameter acquiring module 32 can obtain the wavelength parameter of the laser beam according to the variation of the color parameter of each of the positions in the specific area before and after the laser beam enters into the specific area. The user can set the wavelength parameter acquiring module 32 to read the wavelength parameter of the laser beam in a specific number of times for widespread sampling.

Thereafter, the cursor simulator 10 will display a specific frame to tell the user to use the laser beam to control the cursor 18 on the display frame 16 or send a command (step 60).

The user can use the switching module 38 to set the cursor simulator 10 in the movement mode or the command mode. If the user wants to set the cursor simulator 10 in the movement mode for controlling the movement of the cursor, then the user can use the laser beam to make the cursor 18 stay at the left-lower corner of the display frame 16 for a predetermined period, and the second detecting module 42 will detect it. Thereafter, the cursor simulator 10 will display a “ready” message in the left-lower corner (the second position) to indicate that the cursor simulator 10 has entered the movement mode. Similarly, if the user wants to set the cursor simulator 10 to the command mode for sending commands, then the user can use the laser beam to make the cursor 18 stay at the right-lower corner of the display frame 16 for a predetermined period, and the first detecting module 40 will detect it. Thereafter, the cursor simulator 10 will display a “ready” massage in the right-lower corner (the first position) to indicate that the cursor simulator 10 has entered the command mode.

When the cursor simulator 10 is in the movement mode, the user can move the laser beam to control the position of the cursor 18. In the movement mode, the cursor simulating position generated by the positioning module 34 is the position of the cursor 18. Therefore, when the position of the laser beam in the view scope 22 varies, the cursor simulating position generated by the positioning module 34 will be different so as to make the position of the cursor 18 vary correspondingly.

When the cursor simulator 10 is in the command mode, the user can use the laser beam to generate various commands. For example, the cursor simulator 10 can generate commands separately equal to the command generated by pressing the left key on the mouse once, the command generated by continuously pressing the left key twice, the command generated by releasing the left key, and so on.

Under the command mode, the positioning module 34 will record all of the cursor simulating positions, and then connect the cursor simulating positions so as to form a specific graph, namely, the command code, such as “v”, “\”, “o”, and so on. At this time, the commanding module 44 will apply the command table to find the corresponding command so that the cursor simulator 10 will send out this command. For example, “v” represents the command equal to that generated by pressing the left key on the mouse once, “\” represents the command equal to that generated by continuously pressing the left key on the mouse twice, and “o” represents the command equal to that generated by releasing the left key on the mouse.

In addition, the user also can use the cursor simulator 10 to set various commands, such as the command for adjusting the volume, the command for directly executing a specific program, and so on.

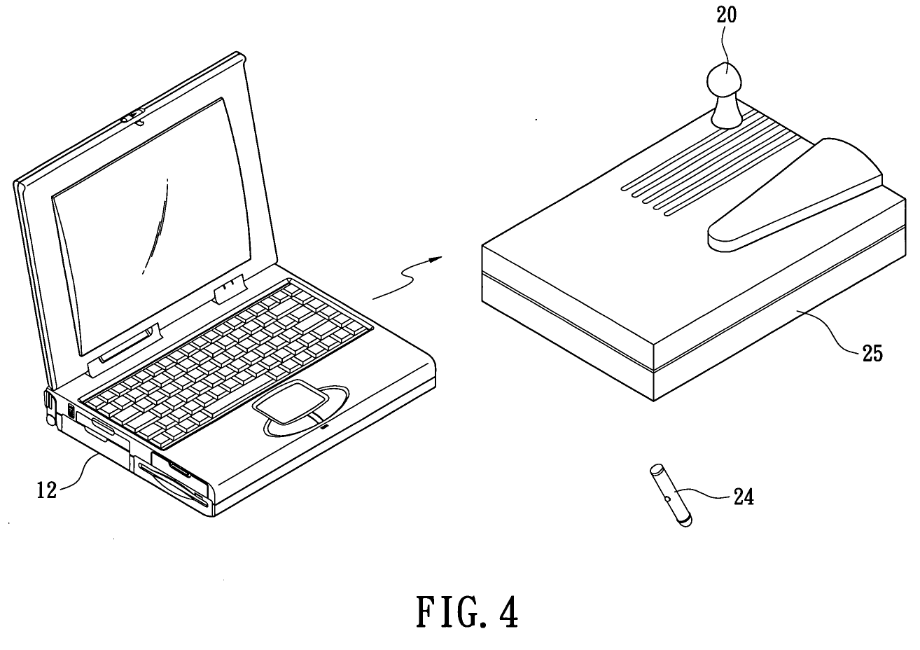

Reference is made to FIG. 4. FIG. 4 is an embodiment according to the present invention. In this embodiment, a camera is embedded in a projector. In addition, the camera also can be externally connected to the projector. As shown in the figure, a main system 12 includes a control program, a projector 25, a laser pointer pen 24 and a camera 20. The camera 20 is embedded into the projector 25. In this way, the user can use the laser pointer pen 24 to emit a laser beam. Thereafter, the camera 20 embedded in the projector 25 will receive the laser beam, and then transform the laser beam signal into a digital signal to be transmitted to the control program in the main system for processing.

In summary, by using the cursor simulator 10 and a simulation method thereof 50 according to the present invention, the user only has to install the cursor simulation software (the cursor simulator 10) in the computer (the main system 12), and then the user can use the common laser pointer pen 24 and video camera (optical reading device 20) to remotely control the cursor. The video camera will read the laser beam emitted by the laser pointer pen 24, and then the cursor simulator 10 will use the variation of the position of the laser beam to simulate the movement of the cursor or the generation of the command. Therefore, the user can use the laser beam emitted by the laser pointer pen 24 to control the position of the cursor and to send commands so as to replace the traditional cursor control device, such as the mouse or the pointer.

Therefore, by using the cursor simulator 10 and a simulation method thereof 50 according to the present invention, the user can remotely control the position of the cursor and the operation of the computer during a briefing. This will make the presentation process smoother and more efficient. Besides, the user uses the laser beam to control the cursor, which will not cause the interference of radio waves, and therefore, the listeners can interact with the reporter by using other wireless devices, such as the wireless network devices or the Bluetooth devices, or using the laser pointer pens.

Furthermore, the cursor simulator 10 and a simulation method thereof 50 according to the present invention not only can simulate the operations of the traditional mouse, but also can replace the mouse when the user does not have a mouse available or does not want to use a mouse. The cursor simulator 10 can be applied on a table surface. For example, the user can use the laser pointer pen 24 to write within the view scope 22, when the cursor simulator 10 is in a write mode. Then, the positioning module 34 will record and connect all of the cursor simulating positions so as to generate the word written by the user.

In addition, the cursor simulator 10 and a simulation method thereof 50 according to the present invention not only can simulate the operations of the traditional mouse and replace the mouse, but also can replace a traditional writing board. The cursor simulator 10 can be used on a table surface to input words. For example, the user can use the laser pointer pen 24 to write in the view scope 22, when the cursor simulator 10 is in a write mode. Then, the positioning module 34 will record and connect all of the cursor simulating positions so as to generate the word written by the user.

Furthermore, the laser pointer pen 24 and the optical reading device 20 applied in the present invention are the common laser pointer pen and the video camera for the PC. The user only has to install the cursor simulation software in the computer, and does not have to further buy other computer peripheral devices. In this way, “electronic garbage” will not be generated.

Those skilled in the art will readily observe that numerous modifications and alterations of the device may be made while retaining the teachings of the invention. Accordingly, the above disclosure should be construed as limited only by the metes and bounds of the appended claims.

1. A cursor simulator installed in a main system, the main system comprising a display device having a predetermined display frame for displaying a cursor, the main system being connected to an optical reading device, the optical reading device having a predetermined view scope, wherein when the optical reading device receives a plurality of first optical signals and a plurality of second optical signals or only receives a plurality of second optical signals, the optical reading device transmits the first and second optical signals to the main system, and the main system transmits the first and second optical signals to the cursor simulator, the cursor simulator comprising:
a receiving module for receiving the first and second optical signals;
a position corresponding module for corresponding the view scope of the optical reading device to the display frame of the display device so as to make each position in the view scope correspond to a position on the display frame;
a display module for detecting the position on the display frame corresponding to the position of the first or the second optical signal in the view scope and displaying the first or the second optical signal on a simulation display frame, wherein the simulation display frame comprises a plurality of optical signal display positions, and each optical signal display position corresponds to a specific position on the display frame;
a wavelength parameter acquiring module for acquiring the wavelength parameter of the first optical signal according to a first color parameter of the optical signal display position before displaying the first optical signal and a second color parameter after displaying the first optical signal; and
a positioning module for reading the color parameter of each of the optical signal display positions on the simulation display frame, wherein when the color parameter is approximately equal to the wavelength parameter, the positioning module will record the optical signal display position, and then generate a cursor simulating position according to the recorded optical signal display positions.

2. The cursor simulator of claim 1, further comprising a floating parameter acquiring module for acquiring a floating parameter according to the different color parameters of the second optical signals displayed on the simulation display frame at different times, wherein the color parameter is approximately equal to the wavelength parameter when the difference between the color parameter and the wavelength parameter is less than or equal to the floating parameter.

3. The cursor simulator of claim 1, further comprising a switching module for switching the cursor simulator between a command mode and a movement mode, the switching module comprising:
a first detecting module for detecting whether the cursor simulating position is equal to a first position in a specific period, wherein if yes, a first switching signal for switching the cursor simulator to the command mode is generated; and
a second detecting module for detecting whether the cursor simulating position is equal to a second position in a specific period, wherein if yes, a second switching signal for switching the cursor simulator to the movement mode is generated.

4. The cursor simulator of claim 3, wherein when the cursor simulator is in the movement mode, the cursor simulating position generated by the positioning module of the cursor simulator is displayed on the position of the cursor on the display frame, and when the cursor simulator is in the command mode, the positioning module records all generated cursor simulating positions, and then generates a command code according to the cursor simulating positions.

5. The cursor simulator of claim 4, further comprising a commanding module having a command table, the command table comprising a plurality of commands and a plurality of command codes, and each of the commands corresponding to a command code, wherein the commanding module finds the command corresponding to the command code generated by the positioning module so that the cursor simulator generates and sends out the command.

6. The cursor simulator of claim 1, wherein the position corresponding module automatically corresponds the view scope of the optical reading device to the display frame of the display device so that each position in the view scope corresponds to a position on the display frame.

7. The cursor simulator of claim 1, wherein a user uses the position corresponding module by a manual method to correspond the view scope of the optical reading device to the display frame of the display device so that each position in the view scope corresponds to a position on the display frame.

8. The cursor simulator of claim 1, wherein a user uses the position corresponding module by an automatic method to correspond the view scope of the optical reading device to the display frame of the display device so that each position in the view scope corresponds to a position on the display frame.

9. A cursor simulating method applied in a main system, the main system comprising a display device having a predetermined display frame for displaying a cursor, and a cursor simulator for executing the cursor simulating method, the main system being connected to an optical reading device having a predetermined view scope, wherein when the optical reading device receives a plurality of first optical signals and a plurality of second optical signals or only receives a plurality of second optical signals, the optical reading device transmits the first and second optical signals to the main system, and the cursor simulator of the main system executes the cursor simulating method, the method comprising:
a position corresponding step for corresponding the view scope of the optical reading device to the display frame of the display device so as to make each position in the view scope correspond to a position on the display frame;
a displaying step for detecting the position on the display frame corresponding to a position of the first or the second optical signal in the view scope and displaying the first or the second optical signal on a simulation display frame, wherein the simulation display frame comprises a plurality of optical signal display positions, and each optical signal display position corresponds to a specific position on the display frame;
a wavelength parameter acquiring step for acquiring the wavelength parameter of the first optical signal according to a first color parameter of the optical signal display position before displaying the first optical signal and a second color parameter after displaying the first optical signal; and
a positioning step for reading the color parameter of each optical signal display position on the simulation display frame, wherein when the color parameter is approximately equal to the wavelength parameter, the positioning module records the optical signal display position, and then generates a cursor simulating position according to the recorded optical signal display positions.

10. The cursor simulating method of claim 9, further comprising a floating parameter acquiring step for acquiring a floating parameter according to the different color parameters of the second optical signals displayed on the simulation display frame at different times, wherein the color parameter is approximately equal to the wavelength parameter when the difference between the color parameter and the wavelength parameter is less than or equal to the floating parameter.

11. The cursor simulating method of claim 9, further comprising a switching step for switching the cursor simulator between a command mode and a movement mode, wherein the switching step comprises:
a first detecting step for detecting whether the cursor simulating position is equal to a first position in a specific period, wherein if yes, a first switching signal for switching the cursor simulator to the command mode is generated; and
a second detecting step for detecting whether the cursor simulating position being equal to a second position in a specific period, wherein if yes, a second switching signal for switching the cursor simulator to the movement mode is generated.

12. The cursor simulator of claim 11, wherein when the cursor simulator is in the movement mode, the cursor simulating position generated by the cursor simulator in the positioning step is displayed on the position of the cursor on the display frame, and when the cursor simulator is in the command mode, in the positioning step, the cursor simulator records all generated cursor simulating positions, and then generates a command code according to the cursor simulating positions.

13. The cursor simulating method of claim 12, wherein the cursor simulator has a command table comprising a plurality of commands and a plurality of command codes, and each command corresponds to a command code, wherein the cursor simulator uses command table to detect the command corresponding to the command code generated in the positioning step so as to generate and send out the command.

14. The cursor simulating method of claim 9, wherein in the position corresponding step, the cursor simulator automatically corresponds the view scope of the optical reading device to the display frame of the display device so that each position in the view scope corresponds to a position on the display frame.

15. The cursor simulating method of claim 9, wherein a user operate the cursor simulator by a manual method to perform the position corresponding step so as to correspond the view scope of the optical reading device to the display frame of the display device so that each position in the view scope corresponds to a position on the display frame.

16. The cursor simulating method of claim 9, wherein a user operates the cursor simulator by an automatic method to perform the position corresponding step so as to correspond the view scope of the optical reading device to the display frame of the display device so that each position in the view scope corresponds to a position on the display frame.

17. A cursor simulation device, comprising:
a main system having a control program installed therein;
a projector;
a laser pointer pen; and
a camera embedded in the projector;
wherein the user uses the laser pointer pen to emit a laser beam, the camera embedded in the projector receive the laser beam, and then the laser beam signal is transformed into a digital signal to be transmitted to the control program in the main system for processing.

18. The cursor simulation device of claim 17, wherein the projector, the laser pointer pen and the camera are common products on the market.
